(19) United States
(12) Patent Application Publication
(10) Pub. No.: US 2012/0026613 A1
(43) Pub. Date: Feb. 2, 2012

(54) ACTUATOR, DRIVE DEVICE, LENS UNIT, IMAGE-CAPTURING DEVICE

(75) Inventors: Yoshihiko SUZUKI, Funabashi-shi (JP); Masaaki TANABE, Fujisawa-shi (JP)

(73) Assignee: NIKON CORPORATION, Tokyo (JP)

(21) Appl. No.: 13/240,268

(22) Filed: Sep. 22, 2011

Related U.S. Application Data
(63) Continuation of application No. PCT/JP2010/001943, filed on Mar. 18, 2010.

(30) Foreign Application Priority Data
Mar. 24, 2009 (JP) 2009-072779

(51) Int. Cl. G02B 7/04; H02N 2/02; H02N 2/12

(52) U.S. Cl. 359/824; 310/328

(57) ABSTRACT

It is an objective of the present invention to provide an actuator that can efficiently enlarge a displacement amount of a moving element. Provided is an actuator that moves a moving element, comprising a drive element that contacts the moving element; a drive unit that moves the moving element in a movement direction by moving a contact portion of the drive element contacting the moving element in the movement direction and in an opposite direction that is opposite the movement direction, such that movement speed in the opposite direction is greater than movement speed in the movement direction; and a displacement enlarging section that joins the drive unit and the drive element to each other, and transmits enlarged displacement of the drive unit to the drive element.

### CROSS REFERENCE TO RELATED APPLICATION

This is a continuation application of PCT/JP2010/001943 filed on Mar. 18, 2010 which claims priority from Japanese Patent Application No. 2009-072779 filed on Mar. 24, 2009, the contents of which are incorporated herein by reference.

### BACKGROUND

1. Technical Field

The present invention relates to an actuator, a drive apparatus, a lens unit, and an image capturing apparatus.

2. Related Art

An actuator is known that moves a moving element in a rotational direction of a shaft by moving the shaft, which is inserted in the moving element, in the rotational direction by extending and contracting a piezoelectric element bonded to an axial end of the shaft, as shown in, for example, Patent Document 1. In this actuator, friction between the shaft and the moving element occurring when the piezoelectric element extends and contracts causes the shaft and the moving element to move as a single body. Furthermore, by causing the piezoelectric element to contract more quickly than it extends, the inertia of the moving element keeps the moving element moving in the same direction when the shaft moves in a direction opposite the movement direction of the moving element.

### Patent Document 1: Japanese Patent Application Publication No. 2006-311788

In the actuator, the displacement amount of the moving element is the same as the extension/contraction amount of the piezoelectric element, and it is necessary to enlarge the extension/contraction amount of the piezoelectric element in order to enlarge the displacement amount of the moving element, Therefore, it is an object of the present invention to provide an actuator that can efficiently enlarge the displacement amount of the moving element.

### SUMMARY

According to a first aspect of the present invention, provided is an actuator that moves a moving element, comprising a drive element that contacts the moving element; a drive unit that moves the moving element in a movement direction by moving a contact portion of the drive element contacting the moving element in the movement direction and in an opposite direction that is opposite the movement direction, such that movement speed in the opposite direction is greater than movement speed in the movement direction; and a displacement enlarging section that joins the drive unit and the drive element to each other, and transmits enlarged displacement of the drive unit to the drive element.

The summary clause does not necessarily describe all necessary features of the embodiments or the present invention. The present invention may also be a sub-combination of the features described above.

### BRIEF DESCRIPTION OF THE DRAWINGS

FIG. 1 is a perspective view of a motor 10 provided with an actuator 100 according to an embodiment of the present invention.

FIG. 2 is an exploded perspective view of the motor 10.

FIG. 3 is a cross-sectional side view of the motor 10.

FIG. 4 is a cross-sectional view over the line 4-4 shown in FIG. 3.

FIG. 5 is a perspective view of an actuator 100.

FIG. 6 is a graph showing the waveform of the drive voltage of the first electromechanical transducer 161 and the waveform of the drive voltage of the second electromechanical transducer 162.

FIG. 7 is a side view of the operation of the stator 150.

FIG. 8 is a side view of an actuator 200 according to another embodiment.

FIG. 9 is a side view of an actuator 600 according to another embodiment.

FIG. 10 is a side view of an actuator 700 according to another embodiment.

FIG. 11 is a side view of an actuator 800 according to another embodiment.

FIG. 12 is a side view of an actuator 900 according to another embodiment.

FIG. 13 is a cross-sectional side view of an image capturing apparatus 1000 including the motor 10.

FIG. 14 is a perspective view of the inside of a lens unit 300 including the actuator 100.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

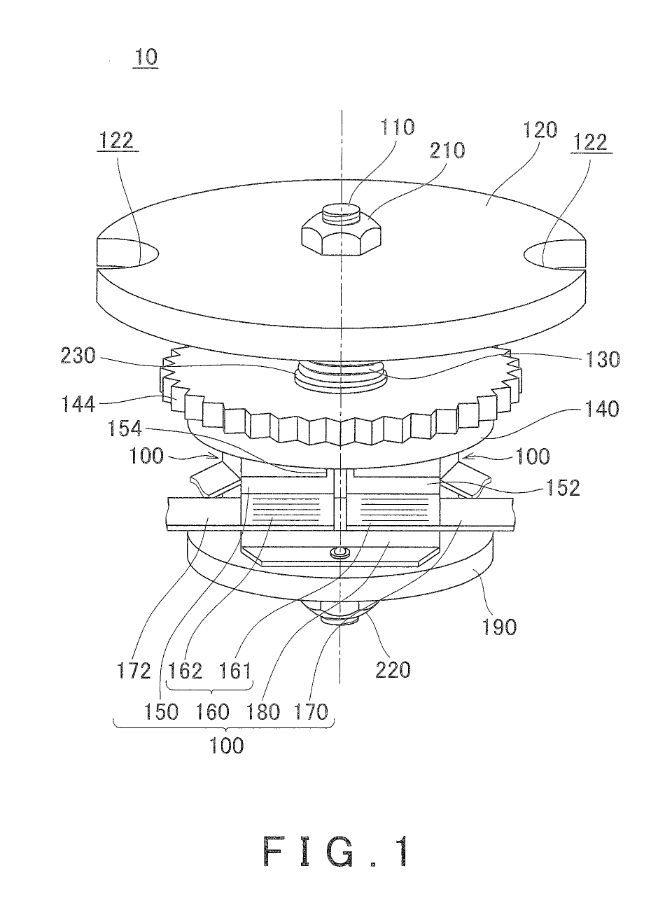

FIG. 1 is a perspective view of a motor 10 provided with an actuator 100 according to an embodiment of the present invention. For ease of explanation, a drive output side in the axial direction of the rotating axle 110 is referred to as the “output side,” and the opposite side is referred to as the “non-output side.” Furthermore, a “planar view” refers to a view of the motor 10 from the axial direction of the rotating axle 110, sometimes simply referred to as the “rotational axis direction,” and a “side view” refers to a view of the motor 10 from the radial direction of the rotating axle 110.

As shown in FIG. 1, the motor 10 includes the rotating axle 110, along with a nut 210, an attachment plate 120, a biasing member 130, a washer 230, a rotor 140, three actuators 100, a base 190, and a nut 220 arranged in the stated order along the rotating axle 110 beginning at the output side. The attachment plate 120 is disc-shaped and the rotating axle 110 is inserted through the center thereof. A pair of U-shaped fastening holes 122 are formed in the attachment plate 120 and are symmetrical with respect to the central axis. The attachment plate 120 is fastened to an apparatus that uses the motor 10 as a drive source, by fasteners such as screws inserted into the fastening holes 122.

The rotor 140 is disc-shaped and the rotating axle 110 is inserted through the center thereof. A gear portion 144 is formed on the output side end of the rotor 140. The biasing member 130, which is exemplified by a compression spring in FIG. 1, has the rotating axle 110 inserted therethrough. The actuators 100 each include a stator 150, an electromechanical transducer 160, a pair of flexible print wiring boards 170 and 172, and a base 180.

The base 180 is a rectangular plate component, and is screwed onto the base 190. The electromechanical transducer 160 includes a first electromechanical transducer 161 and a second electromechanical transducer 162. The first electromechanical transducer 161 and the second electromechanical transducer 162 are layered piezoelectric elements formed by layering piezoelectric elements in the rotational axis direction, and extend and contract in the layering direction when a drive voltage is supplied thereto.

In the present embodiment, the electromechanical transducer 160 includes the first electromechanical transducer 161 and the second electromechanical transducer 162 as separate components. However, the electromechanical transducer 160 may be formed to include the first electromechanical transducer 161 and the second electromechanical transducer 162 integrally by forming, on a single layered piezoelectric element, a pair of extending/contracting sections that extend and contract in the layering direction when voltage is applied thereto.

The first electromechanical transducer 161 and the second electromechanical transducer 162 are arranged in a line in the longitudinal direction of the base 180. The pair of flexible print wiring boards 170 and 172 are arranged in a line in the longitudinal direction of the base 180. The flexible print wiring hoard 170 is sandwiched by the base 180 and the first electromechanical transducer 161, and the flexible print wiring board 172 is sandwiched by the base 180 and the second electromechanical transducer 162.

The stator 150 is formed of an elastic material such as SUS, alumina, silicon carbide, brass, ceramic, or the like. The stator 150 includes a base portion 152 shaped as a rectangular plate and a protrusion 154 that protrudes toward the rotor 140 from the longitudinal center or the base portion 152. One longitudinal edge of the base portion 152 is engaged with the top end or the first electromechanical transducer 161, and the other longitudinal edge of the base portion 152 is engaged with the top end of the second electromechanical transducer 162. The tip of the protrusion 154 is covered in a diamond coating, ceramic coating, or the like to improve abrasion resistance. The protrusion 154 is preferably formed of a functional gradient material.

The flexible print wiring board 170 supplies the first electromechanical transducer 161 with a so-called saw-tooth drive voltage, causing the first electromechanical transducer 161 to extend and contract in the rotational axis direction. The flexible print wiring board 172 supplies the second electromechanical transducer 162 with the so-called saw-tooth drive voltage, causing the second electromechanical transducer 162 to extend and contract in the rotational axis direction, In the present embodiment, a positive drive voltage is applied to the first electromechanical transducer 161 and the second electromechanical transducer 162, but a negative voltage may he applied or an AC voltage that is both positive and negative may be applied instead,

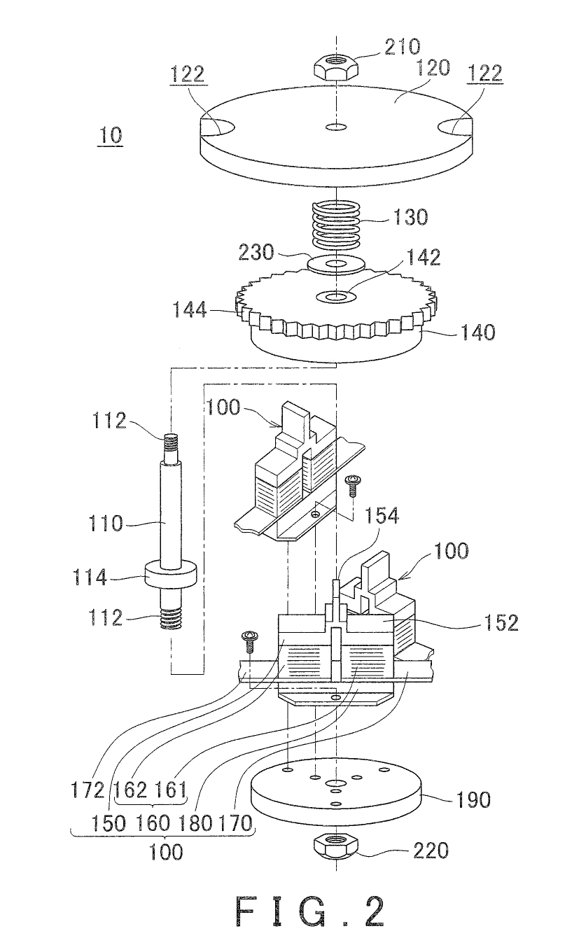

FIG. 2 is an exploded perspective view of the motor 10. As shown in FIG. 2, screws 112 that engage respectively with the nuts 210 and 220 are formed at the axial ends of the rotating axle 110. A disc-shaped flange 114 with an extended diameter is formed between the screws 112. The nut 210, the attachment plate 120, the biasing member 130, the washer 230, and the rotor 140 are arranged on the output side of the flange 114, while the base 190 and the nut 220 are arranged on the non-output side of the flange 114. The three actuators 100 are arranged between the rotor 140 and the base 190, in a manner to surround the rotating axle 110. The rotor 140 is supported in a rotatable manner by the rotating axle 110, via the bearing 142.

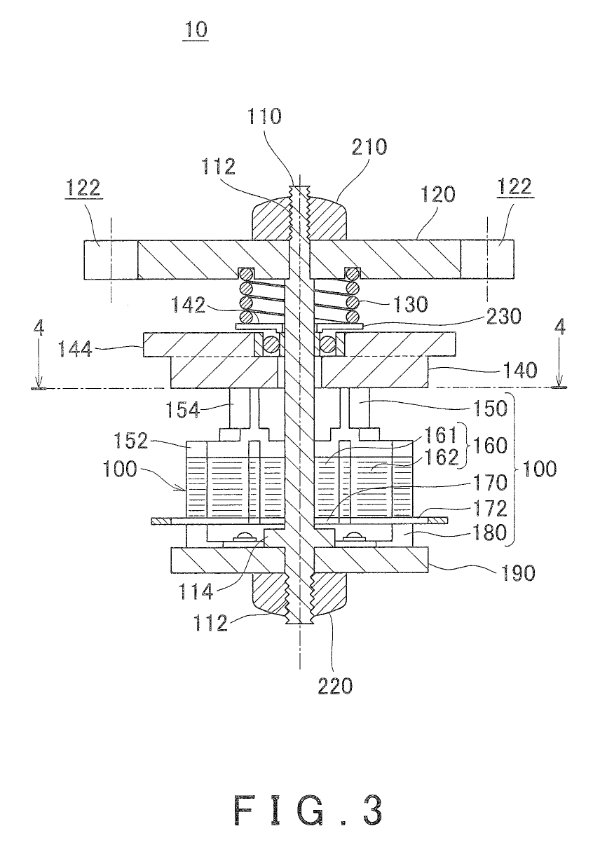

FIG. 3 is a cross-sectional side view of the motor 10. As shown in FIG. 3, the attachment plate 120, the biasing member 130, the washer 230, the rotor 140, the actuator 100, and the base 190 are held in the rotational axis direction by the nuts 210 and 220. The biasing member 130 is elastically compressed in the rotational axis direction, and the rotor 140 is pressed against the actuator 100 via the washer 230. The direction in which the rotor 140, the stator 150, and the electromechanical transducer 160 are arranged is orthogonal to the direction in which the rotor 140 rotates and to the direction in which the protrusion 154, the rotor 140, and components contacting the protrusion 154 and the rotor 140 move, as described further below,

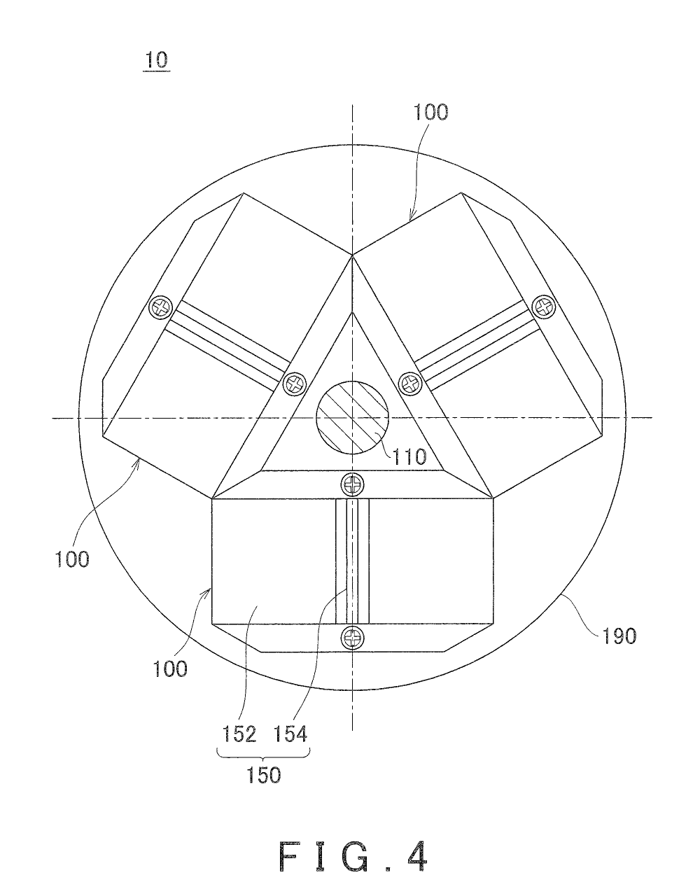

FIG. 4 is a cross-sectional view over the line 4-4 shown in FIG. 3. As shown in FIG. 4, the three actuators 100 are arranged at intervals of 2π/3 around the rotating axle 110. The space enclosed by the actuators 100 is triangular in the planar view. The three protrusions 154 are arranged at intervals of 2π/3 around the rotating axle 110.

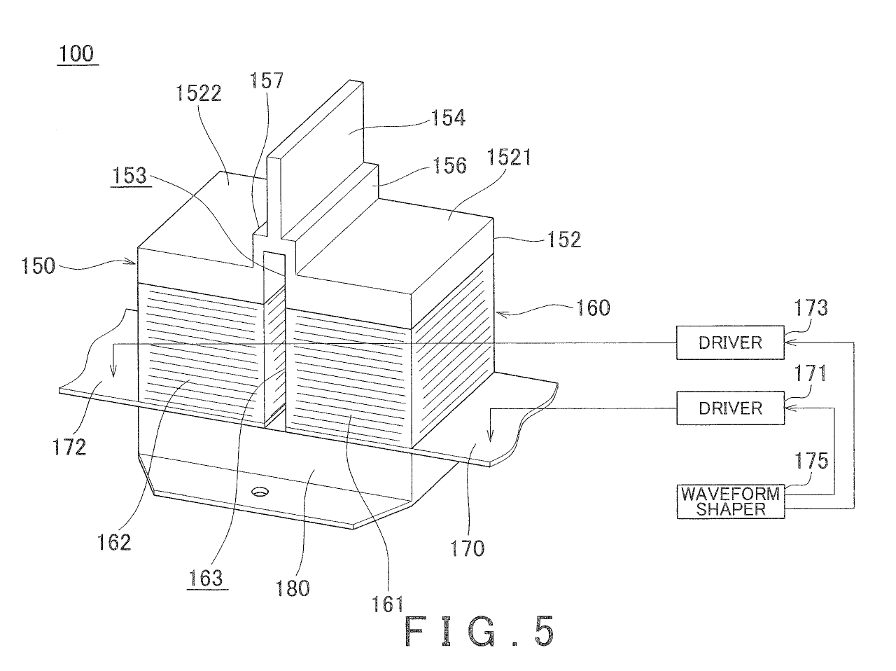

FIG. 5 is a perspective view of an actuator 100. As shown in FIG. 5, in the actuator 100, a gap 163 is formed between the first electromechanical transducer 161 and the second electromechanical transducer 162, such that the first electromechanical transducer 161 and the second electromechanical transducer 162 are separated in a direction orthogonal to the extension and contraction direction, and this direction can be referred to as the “arrangement direction.”

A rectangular groove 153 longitudinally dividing the base portion 152 into two portions is formed in the longitudinal center of the base portion 152 of the stator 150. The groove 153 extends across the entire width of the base portion 152, and is formed to overlap in the rotational axis direction with the gap 163 between the first electromechanical transducer 161 and the second electromechanical transducer 162. Therefore, the entirety of one longitudinal end of the base portion 152, sometimes referred to simply as the “base portion 1521,” is joined with the entire end surface of the first electromechanical transducer 161, and the entirety of the other longitudinal end of the base portion 152, sometimes referred to simply as the “base portion 1522,” is joined with the entire end surface of the second electromechanical transducer 162.

The groove 153 extends to the base end or the protrusion 154 through the base portion 152. As a result, a pair of leg portions 156 and 157 divided in the longitudinal direction of the base portion 152 by the groove 153 are formed at the base end of the protrusion 154. The leg portion 156 extends toward the rotor 140 from the edge of the base portion 1521 on the groove 153 side. The leg portion 157 extends toward the rotor 140 from the edge of the base portion 1522 on the groove 153 side. In other words, the protrusion 154 is supported by the base portion 152 on a base end shaped like an inverted rectangular U and including the leg portions 156 and 157.

The flexible print wiring boards 170 and 172 are connected to a waveform shaper 175 via drivers 171 and 173, respectively. The driver 171 applies the drive voltage with a waveform shaped by the waveform shaper 175 to the first electromechanical transducer 161. The driver 173 applies the drive voltage with a waveform shaped by the waveform shaper 175 to the second electromechanical transducer 162.

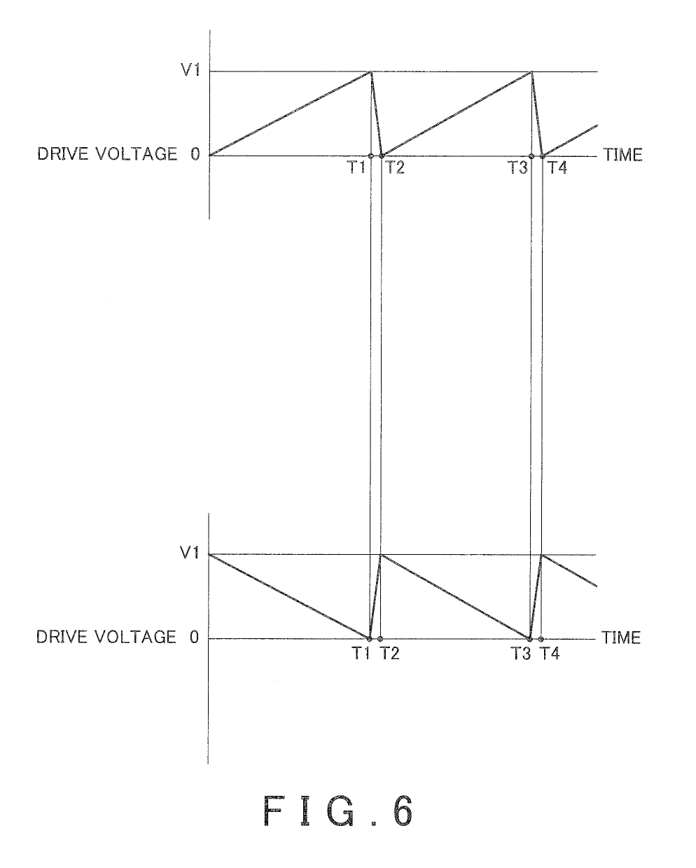

The following describes the operation of the present embodiment. The graphs of FIG. 6 show the waveform of the drive voltage of the first electromechanical transducer 161 and the waveform of the drive voltage of the second electromechanical transducer 162. The upper graph shows the waveform of the voltage applied to the first electromechanical transducer 161, The lower graph shows the waveform of the voltage applied to the second electromechanical transducer 162.

As shown in the upper graph, from time 0 to time T1, the drive voltage applied to the first electromechanical transducer 161 increases from 0 V to V1. As shown in the lower graph, from time 0 to time T1, the drive voltage applied to the second electromechanical transducer 162 decreases from V1 to 0 V.

At time 0, the extension amount of the first electromechanical transducer 161 is 0 and the extension amount of the second electromechanical transducer 162 is at the maximum. Therefore, the protrusion 154 is inclined toward the first electromechanical transducer 161 side. On the other hand, at time T1, the extension amount of the first electromechanical transducer 161 is at the maximum and the extension amount of the second electromechanical transducer 162 is 0.

Therefore, from time 0 to time T1, the operation of the first electromechanical transducer 161 and the second electromechanical transducer 162 causes the protrusion 154 to swing from being inclined toward the first electromechanical transducer 161 side to being inclined toward the second electromechanical transducer 162 side.

Since the rotor 140 is pressed against the tip of the protrusion 154 by the biasing member 130, friction occurs between the tip of the moving protrusion 154 and the rotor 140. The frictional force is set to be greater than the force of the protrusion 154 pressing on the rotor 140. Therefore, the tip of the protrusion 154 and the rotor 140 become a single body that moves from the first electromechanical transducer 161 side toward the second electromechanical transducer 162 side.

As shown in the upper graph, from time T1 to time T2, the drive voltage applied to the first electromechanical transducer 161 decreases from V1 to 0 V. As shown by the lower graph, from time T1 to time T2, the drive voltage applied to the second electromechanical transducer 162 increases from 0 V to V1.

At time T1, as described above, the protrusion 154 is inclined toward the second electromechanical transducer 162 side. On the other hand, at time T2, the extension amount of the first electromechanical transducer 161 is 0 and the extension amount of the second electromechanical transducer 162 is at the maximum. Therefore, the protrusion 154 is inclined toward the first electromechanical transducer 161 side.

As a result, from time T1 to time T2, the operation of the first electromechanical transducer 161 and the second electromechanical transducer 162 causes the protrusion 154 to swing from being inclined toward the second electromechanical transducer 162 side to being inclined toward the first electromechanical transducer 161 side.

It should be noted that the slope of the drive voltage, i.e. the voltage change per unit time, applied to the first electromechanical transducer 161 and the second electromechanical transducer 162 from time T1 to time T2 is greater than the slope of the drive voltage applied to the first electromechanical transducer 161 and the second electromechanical transducer 162 from time 0 to time T1. Therefore, the protrusion 154 swings more quickly from time T1 to time T2 than from time 0 to time T1.

From time T1 to time T2, the combined force of the frictional force between the tip of the protrusion 154 and the rotor 140 and the pressing force of the tip of the protrusion 154 against the rotor 140 is set to be less than the inertial force of the rotor 140. Therefore, the tip of the protrusion 154 slips against the rotor 140, and so the tip of the protrusion 154 swings from the second electromechanical transducer 162 side to the first electromechanical transducer 161 side while the rotor 140 continues rotating in the same direction.

From time T2 to time T3, the drive voltage is applied to the first electromechanical transducer 161 and the second electromechanical transducer 162 in the same manner as from time 0 to time T1. From time T3 to time T4, the drive voltage is applied to the first electromechanical transducer 161 and the second electromechanical transducer 162 in the same manner as from time T2 to time T2. From time T4 onward, the drive voltage is applied to the first electromechanical transducer 161 and the second electromechanical transducer 162 in the same manner as from time 0 to time T4. in other words, the drive voltage with the saw-tooth waveform is repeatedly applied to the first electromechanical transducer 161 and the second electromechanical transducer 162.

From time T2 to time T3, the frictional force between the tip of the protrusion 154 and the rotor 140 is greater than the combined force of the momentum of the rotor 140 and the force of the tip of the protrusion 154 pressing on the rotor 140. Therefore, from time T2 to time T3, the tip of the protrusion 154 and the rotor 140 form a single body that moves from the first electromechanical transducer 161 side toward the second electromechanical transducer 162 side.

From time T3 to time T4, the combined force of the frictional force between the tip of the protrusion 154 and the rotor 140 and the pressing force of the tip of the protrusion 154 against the rotor 140 is set to be less than the inertial force of the rotor 140. Therefore, the tip of the protrusion 154 slips against the rotor 140, and so the tip of the protrusion 154 swings from the second electromechanical transducer 162 side toward the first electromechanical transducer 161 side while the rotor 140 continues rotating in the same direction. By repeating, from time 14 onward, the operation performed from time T2 to time T4, the rotor 140 continues rotating.

In order to rotate the rotor 140 in the opposite direction, the drive voltage with the waveform shown in the lower graph is applied to the first electromechanical transducer 161 and the drive voltage with the waveform shown in the upper graph is applied to the second electromechanical transducer 162.

In the embodiment described above, the electromechanical transducer 160 causes the protrusion 154, which serves as a drive element arranged between the electromechanical transducer 160 and the rotor 140, to move back and forth in the rotational direction of the rotor 140. Furthermore, by causing the extension speed and the contraction speed of the electromechanical transducer 160 to be different, the speed at which the protrusion 154 swings in the opposite direction of the rotational direction is greater than the speed at which the protrusion 154 swings in the rotational direction. As a result, the rotor 140 can continue rotating.

The extension and contraction direction of the electromechanical transducer 160 is orthogonal to the rotational direction of the rotor 140, which is the moving element, and the contacting portion between the rotor 140 and the protrusion 154 protruding from the electromechanical transducer 160 toward the rotor 140 is caused to move in the rotational direction of the rotor 140. As a result, the electromechanical transducer 160 can be housed between the rotor 140 and the base 190. Furthermore, the stator 150 side end of the electromechanical transducer 160 in the extension and contraction direction can he fixed to the base 190. In other words, the electromechanical transducer 160 and the stator 150 serving as the drive element can be housed within the motor 10, and the electromechanical transducer 160 can be supported with a simple structure.

From the above, the actuator 100 according to the present embodiment is suitable for use as a drive source of a rotational motor 10. Furthermore, the actuator 100 is also suitable for use as a drive source of a linear drive motor, as will be described further below. Accordingly, an actuator can be provided that imposes fewer restriction on the movement direction of the moving element, thereby allowing for more freedom of use

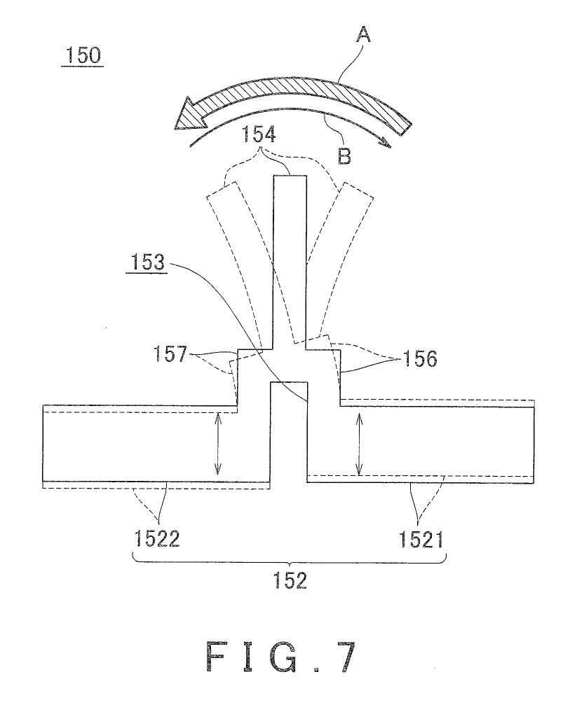

FIG. 7 is a side view of the operation of the stator 150. As shown in FIG. 7, the base portion 1521 at one longitudinal end of the base portion 152 is separated from the base portion 1522 at the other longitudinal end of the base portion 152 by the groove 153. Therefore, as shown by the dashed lines in FIG. 7, the base portion 1521 and the base portion 1522 can move independently in the rotational axis direction, thereby having different relative positions in the rotational axis direction.

For example, as shown by the dashed lines in FIG. 7, the base portion 1521 can move to the rotor 140 side while the base portion 1522 moves to the electromechanical transducer 160 side. In this case, the leg portion 156 formed integrally with the base portion 1521 moves toward the rotor 140 side, while the leg portion 157 formed integrally with the base portion 1522 moves toward the electromechanical transducer 160 side. As a result, the protrusion 154 swings in the direction of the arrow A in FIG. 7, to be inclined toward the second electromechanical transducer 162 side while being supported at a central point between the leg portion 156 and the leg portion 157.

When the base portion 1522 moves toward the rotor 140 side and the base portion 1521 moves toward the second electromechanical transducer 162 side, the leg portion 157 moves toward the rotor 140 side and the leg portion 156 moves toward the second electromechanical transducer 162 side. As a result, the protrusion 154 swings in the direction or the arrow 13 shown in FIG. 7, to be inclined toward the first electromechanical transducer 161 side while being supported at the central point described above.

The distance From the support point of the protrusion 154 to the tip is relatively greater than the distance from the leg portions 156 and 157 to the support point. As a result, the displacement amount of the protrusion 154 along the rotational direction is geometrically greater than the extension/contraction amount of the first electromechanical transducer 161 and the second electromechanical transducer 162. Furthermore, in the electromechanical transducer 160, the second electromechanical transducer 162 is contracted when the first electromechanical transducer 161 is extended, and the first electromechanical transducer 161 is contracted when the second electromechanical transducer 162 is extended. As a result, it is possible to enlarge a height difference between the base portion 1521 fixed to the first electromechanical transducer 161 and the base portion 1522 fixed to the second electromechanical transducer 162. Furthermore, the protrusion 154 elastically deforms with the leg portions 156 and 157 as support points. Accordingly, the relative displacement amount of the protrusion 154 along the rotational direction can be efficiently enlarged with respect to the extension/contraction amount of the first electromechanical transducer 161 and the second electromechanical transducer 162, thereby efficiently enlarging the output of the actuator 100.

In the actuator 100, the pair of leg portions 156 and 157 divided by the groove 153 in the rotational direction of the rotor 140 are disposed on the base end of the protrusion 154, such that the leg portion 156 is supported by the first electromechanical transducer 161 and the leg portion 157 is supported by the second electromechanical transducer 162. As a result, a displacement amount equal to the extension/contraction amount of the first electromechanical transducer 161 can be applied to the leg portion 156 forming one side of the base end of the protrusion 154 in the rotational direction and a displacement amount equal to the extension/contraction amount of the second electromechanical transducer 162 can be applied to the leg portion 157 forming the other side of the base end of the protrusion 154 in the rotational direction. Accordingly, the relative displacement amount of the protrusion 154 along the rotational direction can he efficiently enlarged with respect to the extension/contraction amount of the first electromechanical transducer 161 and the second electromechanical transducer 162, thereby efficiently enlarging the output of the actuator 100.

The protrusion 154 is supported by the end of the first electromechanical transducer 161 on the second electromechanical transducer 162 side and the end of the second electromechanical transducer 162 on the first electromechanical transducer 161 side. Accordingly, the relative displacement amount of the protrusion 154 along the rotational direction can be more efficiently enlarged with respect to the extension/contraction amount of the first electromechanical transducer 161 and the second electromechanical transducer 162, thereby more efficiently enlarging the output of the actuator 100.

Furthermore, the operation of the electromechanical transducer 160 enlarges the horizontal amplitude of the protrusion 154, and therefore it is not necessary to use resonance of the entire motor 10 system. Accordingly, the actuator 100 can provide drive with a frequency that is different from the resonance frequency of the overall motor 10 system.

In the present embodiment, by applying a positive drive voltage to one of the first electromechanical transducer 161 and the second electromechanical transducer 162 and causing a drop in the positive drive voltage applied to the other, the one of the first electromechanical transducer 161 and second electromechanical transducer 162 extends and the other returns to its natural length. However, it is only necessary that the one of the first electromechanical transducer 161 and second electromechanical. transducer 162 extends relative to the other, while the other contracts relative to the one. Therefore, the other may be caused to contract while the one returns to its natural length, by causing a drop in the negative voltage applied to the other while the negative voltage is applied to the one.

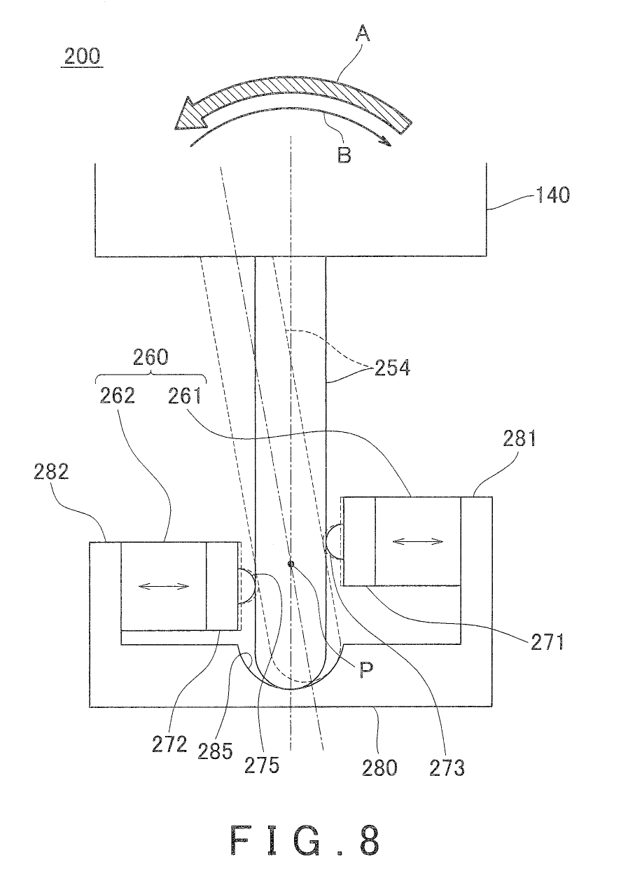

FIG. 8 is a side view of an actuator 200 according to another embodiment, As shown in FIG. 8, the actuator 200 includes a base 280 arranged facing the rotor 140 in the rotational axis direction, a protrusion 254 disposed on the base 280, and an electromechanical transducer 260 supported on the base 280.

The bottom end of the protrusion 254 is formed as a semi-sphere, and a bearing section 285 having a bowl shape into which the bottom end of the protrusion 254 is inserted is formed in the base 280. The curvature radius of the bearing section 285 is greater than the curvature radius of the protrusion 254.

The electromechanical transducer 260 includes a first electromechanical transducer 261 and a second electromechanical transducer 262 arranged in the rotational direction of the rotor 140. The first electromechanical transducer 261 is arranged farther upstream in the rotational direction than the protrusion 254, and the second electromechanical transducer 262 is arranged farther downstream in the rotational direction than the protrusion 254. The first electromechanical transducer 261 and the second electromechanical transducer 262 are supported by supporting walls 281 and 282 formed on the base 280.

The first electromechanical transducer 261 is arranged between the supporting wall 281 and the protrusion 254. One end of the first electromechanical transducer 261 is fixed to the supporting wail 281, and the other end of the first electromechanical transducer 261 is fixed to the base 271. A semi-spherical convex portion 273 is formed on the surface of the base 271 on the protrusion 254 side. The convex portion 273 contacts the bottom end of the protrusion 254. The first electromechanical transducer 261 extends and contracts in a direction tangential to the rotational direction of the rotor 140.

The second electromechanical transducer 262 is arranged between the supporting wall 282 and the protrusion 254. One end of the second electromechanical transducer 262 is fixed to the supporting wall 282, and the other end of the second electromechanical transducer 262 is fixed to the base 272. A semi-spherical convex portion 275 is formed on the surface of the base 272 on the protrusion 254 side. The convex portion 275 contacts the bottom end of the protrusion 254. The second electromechanical transducer 262 extends and contracts in a direction tangential to the rotational direction of the rotor 140.

The first electromechanical transducer 261 and the second electromechanical transducer 262 have different relative positions in the rotating axle direction. Therefore, as shown by the dotted lines in FIG. 8, by causing the first electromechanical transducer 261 and the second electromechanical transducer 262 to extend with the same phase, the protrusion 254 can be swung in the direction shown by the arrow A, with the central point P between the convex portion 273 and the convex portion 275 as a support point. Furthermore, by causing the first electromechanical transducer 261 and the second electromechanical transducer 262 to contract with the same phase, the protrusion 254 can be swung in the direction shown by the arrow B, with the central point P as a support point.

In the present embodiment, the speed used when contracting the first electromechanical transducer 261 and the second electromechanical transducer 262 with the same phase is set to be greater than the speed used when extending the first electromechanical transducer 261 and the second electromechanical transducer 262 with the same phase. As a result, the rotor 140 can continue to rotate from the first electromechanical transducer 261 side toward the second electromechanical transducer 262 side.

In the present embodiment, the distance from the support point P of the protrusion 254 to the tip of the protrusion 254 contacting the rotor 140 is greater than the distance between the support point P of the protrusion 254 and the load center of the protrusion 254. Therefore, the displacement amount of the protrusion 254 in the rotational direction is geometrically greater than the extension/contraction amount of the first electromechanical transducer 261 and the second electromechanical transducer 262.

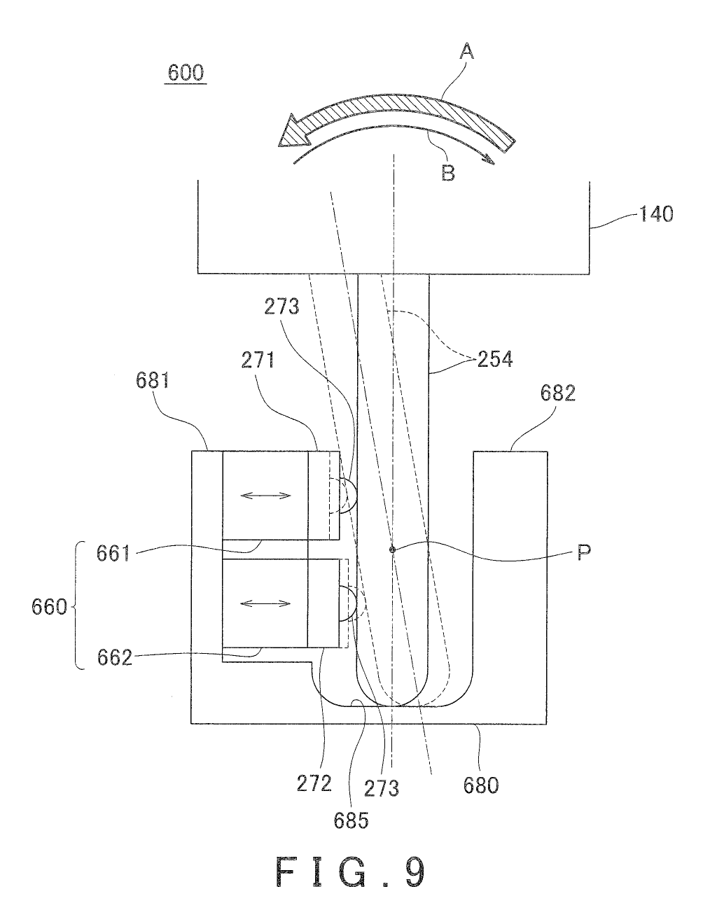

FIG. 9 is a side view of an actuator 600 according to another embodiment. As shown in FIG. 9, the actuator 600 includes a base 680 arranged facing the rotor 140 in the rotational axis direction, a protrusion 254 disposed on the base 680, and an electromechanical transducer 660 supported on the base 680.

The bottom end of the protrusion 254 is formed as a semi-sphere, and a bearing section 685 having a recessed shape into which the bottom end of the protrusion 254 is inserted is formed in the base 680. The width of the bearing section 285 is greater than the width of the bottom end of the protrusion 254.

The electromechanical transducer 260 includes a first electromechanical transducer 661 and a second electromechanical transducer 662 arranged in the rotational axis direction. The first electromechanical transducer 661 and the second electromechanical transducer 662 are arranged farther downstream in the rotational direction than the protrusion 254. The first electromechanical transducer 661 and the second electromechanical transducer 662 are supported by a supporting wall 681 formed on the base 680.

The first electromechanical transducer 661 and the second electromechanical transducer 662 are arranged between the supporting wall 681 and the protrusion 254, One end of each of the first electromechanical transducer 661 and the second electromechanical transducer 662 is fixed to the supporting wall 681, and the other ends Of the first electromechanical transducer 661 and the second electromechanical transducer 662 are respectively fixed to the bases 271 and 272. Semi-spherical convex portions 273 are formed on the surfaces of the bases 271 and 272 on the protrusion 254 side. The convex portions 273 contact the bottom end of the protrusion 254. The first electromechanical transducer 661 and the second electromechanical transducer 662 extend and contract in a direction tangential to the rotational direction of the rotor 140.

A bearing wall 682 is formed on the base 680 further upstream than the protrusion 254 in the rotational direction. The bearing wall 682 faces the supporting wall 681, and is formed a certain distance from the protrusion 254 to support the protrusion 254 when inclined upstream in the rotational direction. The distance between the bearing wall 682 and the protrusion 254 is set such that the angle of inclination of the protrusion 254 in the rotational direction, as shown by the dashed lines in FIG. 9, is equal to the angle of inclination of the protrusion 254 in the direction opposite the rotational direction.

Both the first electromechanical transducer 261 and the second electromechanical transducer 262 are positioned downstream from the protrusion 254 in the rotational direction. The first electromechanical transducer 261 is arranged closer to the rotor 140 than the second electromechanical transducer 262. Therefore, as shown by the dotted lines in FIG. 9, by causing the first electromechanical transducer 261 to contract while causing the second electromechanical transducer 262 to extend, the protrusion 254 can be swung in the direction shown by the arrow A, with the central point P between the upper and lower convex portions 273 as a support point. Furthermore, by causing the first electromechanical transducer 261 to extend and causing the second electromechanical transducer 262 to contract, the protrusion 254 can be swung in the direction shown by the arrow B, with the central point P as a support point.

In the present embodiment, the speed used when extending the first electromechanical transducer 261 and contracting the second electromechanical transducer 262 is set to be greater than the speed used when contracting the first electromechanical transducer 261 and extending the second electromechanical transducer 262. As a result, the rotor 140 can continue to rotate from the first electromechanical transducer 661 side toward the second electromechanical transducer 662 side.

In the present embodiment, the distance from the support point P of the protrusion 254 to the tip of the protrusion 254 contacting the rotor 140 is greater than the distance between the support point P of the protrusion 254 and the load center of the protrusion 254. Therefore, the displacement amount of the protrusion 254 in the rotational direction is geometrically greater than the extension/contraction amount of the first electromechanical transducer 661 and the second electromechanical transducer 662.

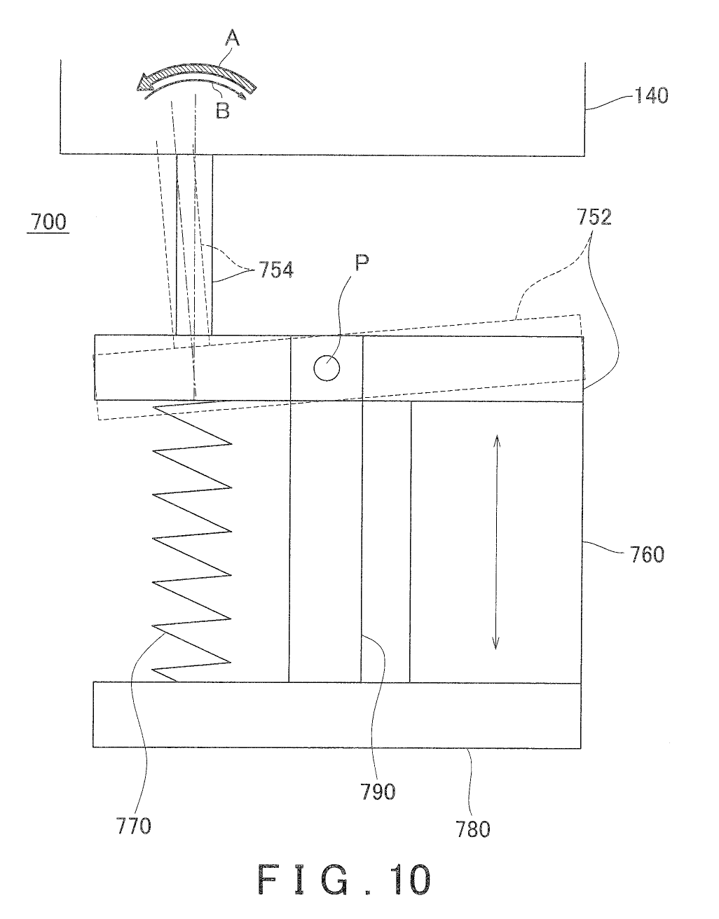

FIG. 10 is a side view of an actuator 700 according to another embodiment. As shown in FIG. 10, the actuator 700 includes a base 780 arranged facing the rotor 140 in the rotational axis; direction, a pillar 790 supported on the base 780, an electromechanical transducer 760, an elastic member 770, a base 752 that is rotatably supported on the top end of the pillar 790, and a protrusion 754 that is formed on the base 752.

The electromechanical transducer 760, the pillar 790, and the elastic member 770 are arranged in the rotational direction in the stated order. The bottom and top ends of the electromechanical transducer 760 are respectively fixed to the base 780 and the base 752. The bottom end of the pillar 790 is fixed to the base 780, and the center of the base 752 in the rotational direction is connected to the top end of the pillar 790 in a manner to allow rotation. The base 752 is supported by the top end of the pillar 790 in a manner to allow rotation on an axis that extends along the direction of the rotational radius, with the center of the base 752 in the rotational direction as a support point.

The elastic member 770 is a compression spring. The bottom end of the elastic member 770 is fixed to the base 780 and the top end of the elastic member 770 is fixed to the base 752. The protrusion 754 is arranged on a line extending from the axis of the elastic member 770, and the tip of the protrusion, 754 contacts the rotor 140.

As shown by the dashed lines in FIG. 10, by extending the electromechanical transducer 760, the side of the base 752 that is upstream in the rotational direction moves toward the rotor 140, and the side of the base 752 that is upstream in the rotational direction moves against the bias force of the elastic member 770 to move away from the rotor 140. As a result, the protrusion 754 can be swung downstream in the rotational direction.

Furthermore, by contracting the electromechanical transducer 760, the side of the base 752 that is upstream in the rotational direction moves away from the rotor 140, and the side of the base 752 that is downstream in the rotational direction uses the bias of the elastic member 770 to move toward the rotor 140. As a result, the protrusion 254 can he swung upstream in the rotational direction.

In the present embodiment, the speed at which the electromechanical transducer 760 contracts is set to be Beater than the speed at which the electromechanical transducer 760 extends. As a result, the rotor 140 can continue to rotate in one direction.

In the present embodiment, the distance from the support point of the protrusion 754 to the tip of the protrusion 754 contacting the rotor 140 is greater than the distance from the support point of the protrusion 754 to the rotational center P of the base 752. Therefore, the displacement amount of the protrusion 254 in the rotational direction is geometrically greater than the extension/contraction amount of the electromechanical transducer 760.

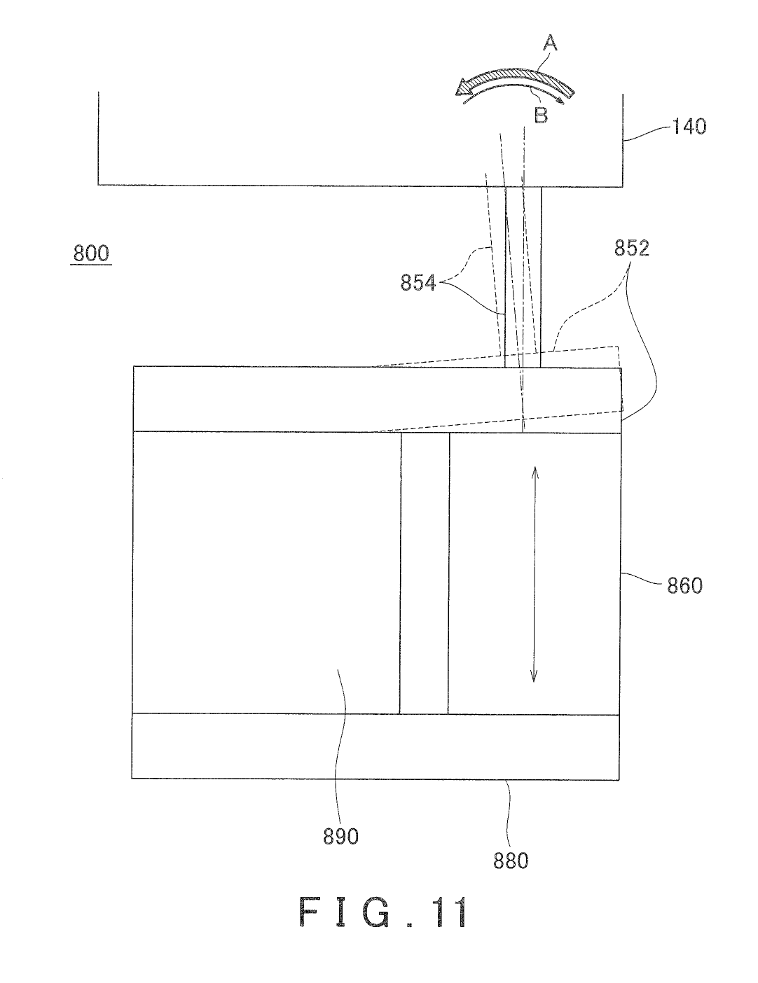

FIG. 11 is a side view of an actuator 800 according to another embodiment. As shown in FIG. 11, the actuator 800 includes a base 880 arranged facing the rotor 140 in the rotational axis direction, a box 890 supported on the base 880, an electromechanical transducer 860, base 852 fixed to the top end of the box 890 and the top end of the electromechanical transducer 860, and a protrusion 854 that is formed on the base 852.

The electromechanical transducer 860 and the box 890 are arranged in the rotational direction in the stated order. The bottom end of the electromechanical transducer 860 is fixed to the base 880, and the top end or the electromechanical transducer 860 is fixed to the base 852 on the side thereof upstream in the rotational direction. The bottom end of the box 890 is fixed to the base 880, and the top end of the box 890 is fixed to the base 852 on the side thereof downstream in the rotational direction. The protrusion 854 is arranged on a line extending from the axis of the electromechanical transducer 860, and the tip of the protrusion 854 contacts the rotor 140.

The region of the base 852 fixed to the box 890 is immobile, but the region of the base 852 further upstream in the rotational direction than the fixed region can be elastically deformed, with a support point P on the upstream end of the fixed region in the rotational direction. As shown by the dashed lines in FIG. 11, by extending the electromechanical transducer 860, the side of the base 852 that is upstream in the rotational direction moves toward the rotor 140, with the support point P as a support point. As a result, the protrusion 854 can be swung downstream in the rotational direction.

By contracting the electromechanical transducer 860, the side of the base 852 that is upstream in the rotational direction moves away from the rotor 140, with the support point P as a support point, As a result, the protrusion 854 can be swung upstream in the rotational direction.

In the present embodiment, the speed used when contracting the electromechanical transducer 860 is set to be greater than the speed used when extending the electromechanical transducer 860. As a result, the rotor 140 can continue to rotate in one direction.

In the present embodiment, the distance from the support point of the protrusion 854 to the tip of the protrusion 854 contacting the rotor 140 is greater than the distance from the support point of the protrusion 854 to the support point P of the base 752 fixed to the box 890. Therefore, the displacement amount of the protrusion 854 in the rotational direction is geometrically greater than the extension/contraction amount of the electromechanical transducer 860,

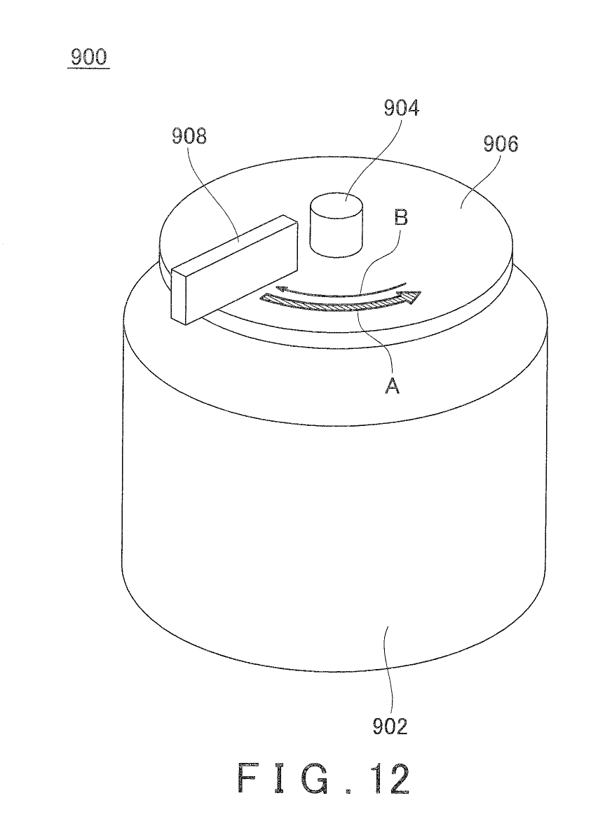

FIG. 12 is a side view of an actuator 900 according to another embodiment. As shown in FIG. 12, the actuator 900 is a DC motor, and includes a drive unit 902, a rotating axle 904, a rotator 906, and a drive element 908.

The drive unit 902 rotates the rotating axle 904. The rotator 906 is a disc fixed to the rotating axle 904, and the rotating axle 904 is inserted through the center of the rotator 906. The drive element 908 is provided on the rotator 906. The drive element 908 is a protrusion that protrudes from the rotator 906 toward the rotor 140 side to contact the rotor 140, and extends in a radial direction from the rotational center.

In the present embodiment, the rotational speed of the rotating axle 904 in the clockwise direction, indicated by the arrow B, is set to be greater than the rotational speed of the rotating axle 904 in the counter-clockwise direction, indicated by the arrow A. As a result, the rotor 140 can continue rotating in one direction.

In the present embodiment, the drive element 908 contacting the rotor 140 is arranged on the rotator 906 and extends in the radial direction from the rotational center, and the rotational radius of the work point at which the load from the drive element 908 affects the rotor 140 is greater than the rotational radius of the rotating axle 904. Therefore, the displacement amount of the drive element 908 in the rotational direction is geometrically greater than the displacement amount of the rotating axle 904 in the rotational direction.

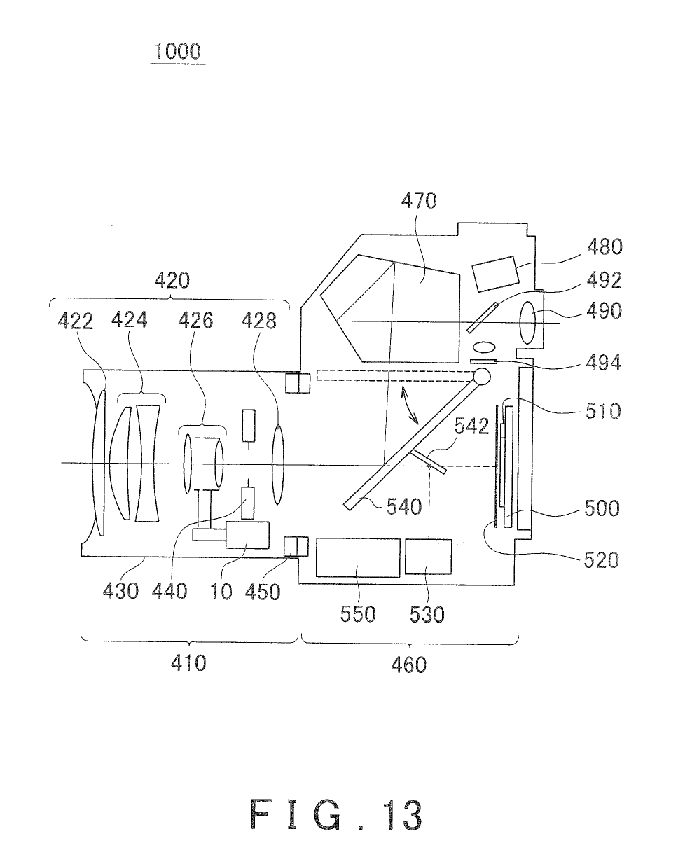

FIG. 13 is a cross-sectional side view of an image capturing apparatus 1000 including the motor 10. The image capturing apparatus 1000 includes an optical component 420, a lens barrel 430, the motor 10, an image capturing section 500, and a control section 550. The lens barrel 430 houses the optical component 420.

The motor 10 moves the optical component 420. The image capturing section 500 captures an image focused by the optical component 420. The control section 550 controls the motor 10 and the image capturing section 500.

The image capturing apparatus 1000 includes a body 460 and a lens unit 410 containing the optical component 420, the lens barrel 430, and the motor 10. The lens unit 410 is detachably mounted on the body 460, via a mount 450.

The optical component 420 includes a front lens 422, a compensator lens 424, a focusing lens 426, and a main lens 428 arranged in the stated order from the left side of FIG. 13, which is the end at which light enters. An iris unit 440 is arranged between the focusing lens 426 and the main lens 428.

The motor 10 is arranged below the focusing lens 426, which has a relatively small diameter, in the approximate center of the lens barrel 430 in the direction of the optical axis. As a result, the motor 10 can be housed in the lens barrel 430 without increasing the diameter of the lens barrel 430. The motor 10 may cause the focusing lens 426 to move forward or backward along a track in the direction of the optical axis, for example.

The body 460 houses an optical component that includes a main mirror 540, a pentaprism 470, and an eyepiece system 490. The main mirror 540 moves between a standby position, in which the main mirror 540 is arranged diagonally in the optical path of the light incident through the lens unit 410, and an image capturing position, shown by the dotted line in FIG. 13, in which the main mirror 540 is raised above the optical path of the incident light.

When in the standby position, the main mirror 540 guides the majority of the incident light toward the pentaprism 470 arranged thereabove. The pentaprism 470 projects the reflection of the incident light toward the eyepiece system 490, and so the image on the focusing screen can be seen correctly from the eyepiece system 490. The remaining incident light is guided to the light measuring unit 480 by the pentaprism 470. The light measuring unit 480 measures the intensity of this incident light, as well as a distribution or the like of this intensity.

A half mirror 492 that superimposes the display image formed by the finder liquid crystal 494 onto the image of the focusing screen is arranged between the pentaprism 470 and the eyepiece system 490. The display image is displayed superimposed on the image projected from the pentaprism 470.

The main mirror 540 has a sub-mirror 542 formed on the back side of the surface facing the incident light. The sub-mirror 542 guides a portion of the incident light passed through the main mirror 540 to the distance measuring unit 530 arranged therebelow. Therefore, when the main mirror 540 is in the standby position, the distance measuring unit 530 can measure the distance to the subject. When the main mirror 540 moves to the image capturing position, the sub-mirror 542 is also raised above the optical path of the incident light.

A shutter 520, an optical filter 510, and an image capturing section 500 are arranged to the rear of the main mirror 540 in the stated order. When the shutter 520 is open, the main mirror 540 arranged immediately in front of the shutter 520 moves to the image capturing position, and so the incident light travels to the image capturing section 500. Therefore, the image formed by the incident light can be converted into an electric signal. As a result, the image capturing section 500 can capture the image formed by the lens unit 410.

In the image capturing apparatus 1000, the lens unit 410 and the body 460 are electrically connected to each other. Therefore, an autofocus mechanism can be formed by controlling the rotation of the motor 10 while referencing the information concerning the distance to the subject detected by the distance measuring unit 530 in the body 460, for example. As another example, a focus aid mechanism can be formed by the distance measuring unit 530 referencing the displacement amount of the motor 10. The motor 10 and the image capturing section 500 are controlled by the control section 550 in the manner described above.

In the manner described above, the output torque of the motor 10 can be efficiently increased. Therefore, since the drive force of the autofocus mechanism can be efficiently increased, the autofocus mechanism can receive a large drive force while conserving power.

The above describes a case in which the focusing lens 426 is driven by the motor 10, but the motor 10 may instead drive opening and closing of the iris unit 440, movement of the variator lens in a zoom lens, or the like. In such a case, by exchanging information with the light measuring unit 480 and the finder liquid crystal 494 in the form of electric signals, the motor 10 can achieve automatic exposure, scene mode execution, bracket image capturing, or the like.

The motor 10 can be used in the manner described above to generate Favorable drive in an optical system, such as an image capturing apparatus or binoculars, or in a focusing mechanism, a ?Dom mechanism, or blur correcting mechanism, for example. Furthermore, the motor 10 can be used in precision stages such as an electron beam lithography apparatus, in various detection stages, in a movement mechanism for a cell injector used in biotechnology, or in power sources such as a mobile bed or a nuclear magnetic resonance apparatus, but are not limited to use in these ways.

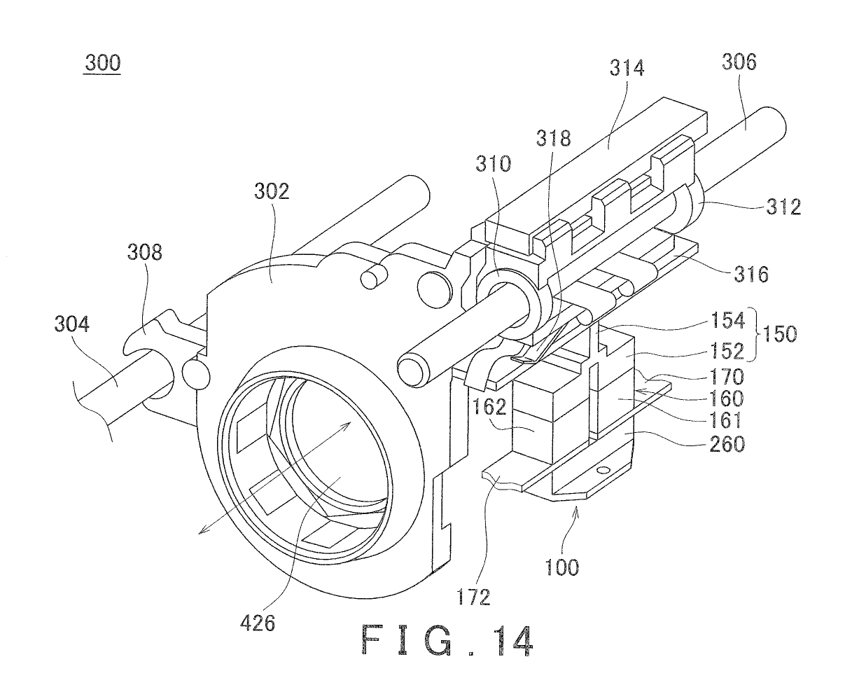

FIG. 14 is a perspective view of the inside of a lens unit 300 including the actuator 100. The lens unit 300 can be attached to the body 460. As shown in FIG. 14, the lens unit 300 includes the focusing lens 426, a lens holding frame 302 holding the focusing lens 426, and a pair of guide bars 304 and 306 that guide the movement of the lens holding frame 302 in the direction of the optical axis. A bearing section 308 is disposed on the left side of the lens holding frame 302, and a front and back pair of bearing sections 310 and 312 are disposed above and to the right of the lens holding frame 302. The guide bar 304 is slidably inserted into the bearing section 308, and the guide bar 306 is slidably inserted into the bearing sections 310 and 312.

The bearing section 310 and the bearing section 312 are joined by a stay 314 that extends in the direction of the optical axis. A moving body 316 shaped as a rectangular plate whose longitude is in the direction of the optical axis is hung from the bottom portion of the stay 314 in a manner to be movable up and down. A flat spring 318 is arranged between the bottom portion of the stay 314 and the moving body 316. The flat spring 318 biases the moving body 316 downward.

The actuator 100 is arranged below the moving body 316, and the moving body 316 is pressed against the protrusion 154 of the actuator 100 by the flat spring 318. The actuator 100 is arranged such that the first electromechanical transducer 161 and the second electromechanical transducer 162 are lined up in the direction of the optical axis. Therefore, the operation of the actuator 100 described above causes a thrust force from the protrusion 154 toward the moving body 316 in the direction of the optical axis, thereby causing the lens holding frame 302 and the focusing lens 426 to move in the direction of the optical axis.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

What is claimed is:

1. An actuator that moves a moving element, comprising:
a drive element that contacts the moving element;
a drive unit that moves the moving element in a movement direction by moving a contact portion of the drive element contacting the moving element in the movement direction and in an opposite direction that is opposite the movement direction, such that movement speed in the opposite direction is greater than movement speed in the movement direction; and
a displacement enlarging section that joins the drive unit and the drive element to each other, and transmits enlarged displacement of the drive unit to the drive element.

2. The actuator according to claim 1, wherein
the drive unit is an electromechanical transducer that is arranged on a side of the drive element opposite the moving element and supplied with power to relatively extend and contract in a direction orthogonal to the movement direction of the moving element, such that the extension speed and the contraction speed are different, thereby moving the moving element in the movement direction by moving the contact portion of the drive element contacting the moving element in the movement direction and in the opposite direction such that the movement speed in the opposite direction is greater than the movement speed in the movement direction.

3. The actuator according to claim 2, wherein
the electromechanical transducer includes a pair of extending/contracting sections that are separated from each other in the movement direction of the moving element, and
when one of the extending/contracting sections extends relative to the other, the other extending/contracting section contracts relative to the one.

4. The actuator according to claim 2, wherein the drive element includes:
a pair of leg portions that extend from the electromechanical transducer side to the moving element side in a direction orthogonal to the movement direction of the moving element and that are separated from each other in the movement direction of the moving element by a groove that is formed on an end of the drive element from the electromechanical transducer side to the moving element side, and
a pair of extending/contracting sections, one of the extending/contracting sections supporting one of the leg portions and the other extending/contracting section supporting the other leg portion, and one of the extending/contracting sections relatively extending with respect to the other when the other extending/contracting section relatively contracts with respect to the one.

5. The actuator according to claim 2, wherein
the drive element is a protrusion that extends from the electromechanical transducer side toward the moving element in a direction orthogonal to the movement direction of the moving element.

6. A drive apparatus comprising:
the actuator according to claim 1; and
a rotor serving as the moving element that is rotated by the actuator.

7. A drive apparatus comprising:
the actuator according to claim 1; and
a slider serving as a moving element that is linearly moved by the actuator.

8. A lens unit comprising:
the drive apparatus according to claim 6; and
an optical component that is moved in a direction of an optical axis by the drive apparatus.

9. A lens unit comprising:
the drive apparatus according to claim 7; and
an optical component that is moved in a direction of an optical axis by the drive apparatus.

10. An image capturing apparatus comprising:
the drive apparatus according to claim 6;
an optical component that is moved in a direction of an optical axis by the drive apparatus; and
an image capturing section that captures an image focused by the optical component.

11. An image capturing apparatus comprising:
the drive apparatus according to claim 7;
an optical component that is moved in a direction of an optical axis by the drive apparatus; and
an image capturing section that captures an image focused by the optical component.
